(19) United States
(12) Patent Application Publication
(10) Pub. No.: US 2026/0029605 A1
(43) Pub. Date: Jan. 29, 2026

(54) OPTICAL FIBER RIBBON STORAGE DEVICE FOR USE IN SPLICE CLOSURES

(71) Applicant: OFS Fitel, LLC, Norcross, GA (US)

(72) Inventors: Josiah A Breda-Nixon, Buford, GA (US); Austin M Wartko, Kennesaw, GA (US)

(73) Assignee: OFS Fitel, LLC, Norcross, GA (US)

(21) Appl. No.: 18/993,539

(22) PCT Filed: Jul. 11, 2023
(86) PCT No.: PCT/US2023/027352

§ 371 Date: Jan. 11, 2025

(51) Int. Cl. G02B 6/44

(52) U.S. Cl. CPC G02B 6/4457

(57) ABSTRACT

A storage device for an optical fiber ribbon. A spool includes a hub, a bottom flange, and a top flange. A spool opening extends axially through the hub and the flanges, and a circular array of recesses are formed along the edge of the opening in the bottom flange. A base has a number of circularly arrayed, pawls for engaging the recesses along the edge of the spool opening in the bottom flange so that when the bottom flange is engaged with the pawls on the base, the spool can rotate in only one winding direction. The hub has a hook member on its circumference which is formed to engage an optical fiber ribbon at a midpoint along its length while maintaining a specified minimum bend radius. When the ribbon is looped around the hook member and the spool is wound, two equal lengths of the ribbon are wound next to one another on the hub for storage. Designated fibers of the ribbon then are accessible from the stored lengths of the ribbon for splicing or other handling.

### CROSS REFERENCE TO RELATED APPLICATION

This application claims priority under 35 U.S.C. § 119(e) of U.S. Provisional Patent Application No. 63/359,961 filed Jul. 11, 2022, titled “Spool Solution for Ribbon Fiber Storage in Closure,” the entire contents of which are incorporated herein by reference.

### BACKGROUND OF THE INVENTION

### Field of the Invention

The present invention relates to management and storage of optical fibers, particularly optical fiber ribbons.

### Discussion of the Known Art

For above ground or aerial installations, fiber optic cable manufacturers recommend that a certain length of cable slack be formed midspan along the cable and stored next to a splice closure The closure may be mounted on a strand that extends parallel to the installed cable. When lifted to an elevated position by a service vehicle, an installer can then use the stored cable slack to lower the closure to the ground, and splice selected fibers in the cable to outside fibers that are routed to the closure.

As shown in FIG. 1, a slack length of an aerial trunk cable 10 may be configured and retained midspan in coiled form 12, next to a splice closure 14. Alternatively, the slack length of the cable 10 may be configured and retained along the cable in a double coiled or “snowshoe” form 16 near the closure 14, as in FIG. 2. The minimum diameter of the coiled slack cable 10 depends on the particular construction of the cable, its fiber count, and the O.D. of the cable. The minimum length of the cable slack depends on local conditions such as the installed height of the cable 10, and the degree to which the cable can be accessed by service vehicles. See generally, OFS Fitel, LLC, “Aerial Installation Guidelines for Fiber Optic Cable,” Installation Practice IP-003 (September 2013). The splice closure 14 may be a commercially available product, e.g., a midspan clamshell hardened terminal (MCHT) available from Go!Foton. The closure 14, which must be tightly water sealed, usually houses a splice tray, an optical splitter, and has internal storage areas or baskets in which slack cable fibers can be stored.

Once the closure 14 is lowered, the jacket on the slack length of the cable 10 is opened by an installer for about, e.g., one meter over its length to expose the optical fibers contained in the cable. Fibers designated to be spliced to outside fibers, e.g, to service nearby network users, are identified and spliced by the installer to the outside fibers after the latter are routed to the closure 14. Fibers not designated for splicing or other applications are not disturbed and are allowed to continue through the cable 10.

When the trunk cable 10 contains a number of optical fiber ribbons, wherein each ribbon comprises many fibers 16 bonded alongside one another in a way that allows them to be individually separated as shown in FIG. 3, it can often happen that not all the bonded fibers 16 of a given ribbon are to be spliced or otherwise handled at the closure 14. In such a case, the given ribbon, less those fibers that have been separated and removed, must be allowed to continue through the cable 10 so that the remaining fibers of the given ribbon can be designated for use downstream of the cable 10.

The storage areas within the closure 14 must be dimensioned and formed large enough to contain the remainder of the given ribbon safely, and ensure that the ribbon will not be urged to bend below a specified minimum radius. This constraint can cause the closure 14 to be visually unappealing, costly, and difficult to maintain in an outdoor, watertight condition. Accordingly, there is a present need for a compact device capable of safely storing an optical fiber ribbon inside of a midspan closure, and which can be easily used by an installer in the field.

### SUMMARY OF THE INVENTION

According to the invention, a storage device for an optical fiber ribbon includes a spool including a hub having an axis, a bottom flange at a first side end of the hub, and a top flange at a second side end of the hub opposite the first side end. A circular spool opening is formed axially through the hub, the bottom, and the top flanges, and a circular array of successive, inclined recesses are formed circumferentially along the edge of the spool opening in the bottom flange.

The storage device also includes a base having a number of circularly arrayed, upwardly projecting pawls for engaging the recesses along the edge of the spool opening in the bottom flange. The recesses along the edge of the opening in the bottom flange, and the projecting pawls on the base, are dimensioned and configured so that when the bottom flange is placed on the base and the pawls engage the recesses along the edge of the opening in the flange, the spool can be freely rotated about its axis in only one winding direction.

The spool hub has a hook member formed on the outer circumference of the hub, and the hook member is dimensioned and formed to engage a length of an optical fiber ribbon at a midpoint along the length of the ribbon while maintaining a specified minimum bend radius for the ribbon. Thus, when the ribbon is engaged with the hook member on the spool hub, and the spool is engaged with the pawls on the base and rotated in the winding direction, the ribbon loops around the hook member at the midpoint of the ribbon length, two substantially equal lengths of the ribbon are wound next to one another on the hub for storage, and designated fibers of the ribbon are accessible from the stored lengths of the ribbon for splicing or other handling.

For a better understanding of the invention, reference is made to the following description taken in conjunction with the accompanying drawing and the appended claims.

### BRIEF DESCRIPTION OF THE DRAWING FIGURES

In the drawing:

FIG. 1 shows a slack length of an installed trunk cable supported for storage along the cable in a coiled configuration, next to a splice closure;

FIG. 2 shows a slack length of an installed trunk cable supported for storage along the cable in a double-coiled or snowshoe configuration, next to a splice closure;

FIG. 3 illustrates the separation of individual optical fibers of an optical fiber ribbon;

FIG. 4 is an isometric top view of a storage spool for an optical fiber ribbon according to the invention;

FIG. 5 is an isometric bottom view of a storage spool for an optical fiber ribbon according to the invention;

FIG. 6 is an isometric top view of a base for the storage spool of FIGS. 4 and 5 according to the invention; and

FIG. 7 illustrates winding a length of an optical fiber ribbon on the storage spool according to the invention.

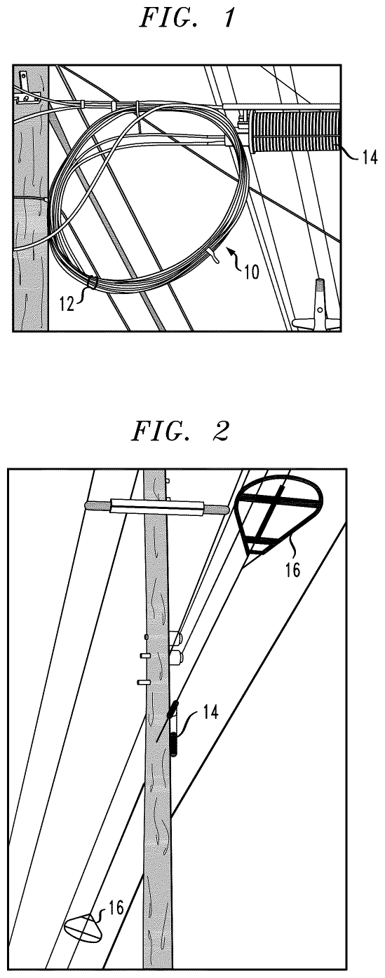

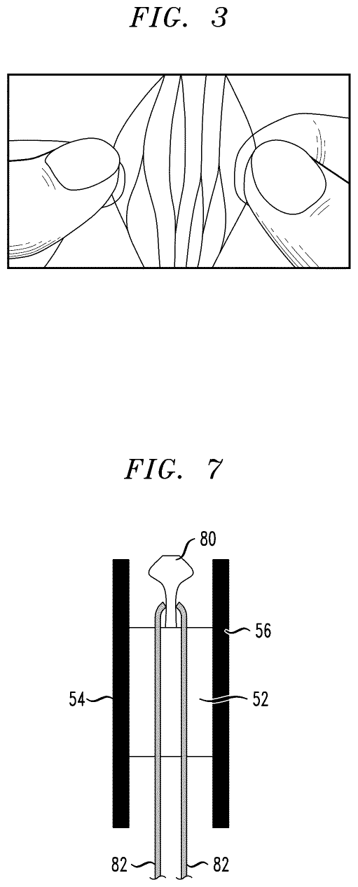

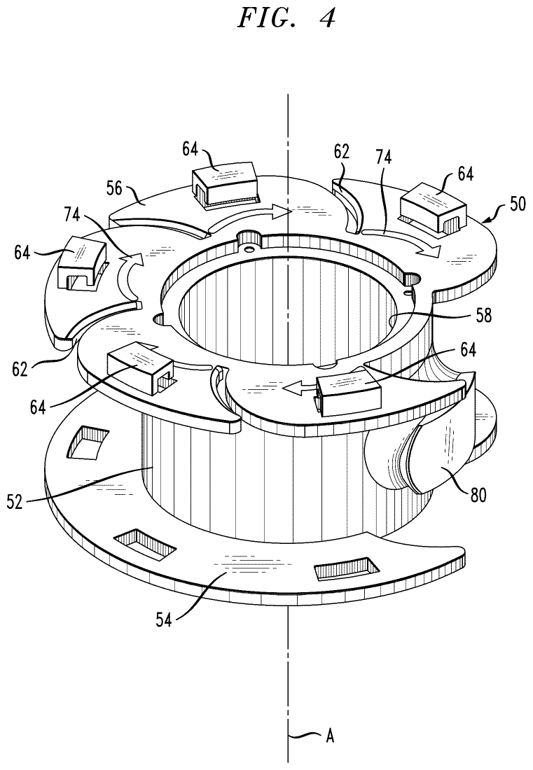

### DETAILED DESCRIPTION OF THE INVENTION

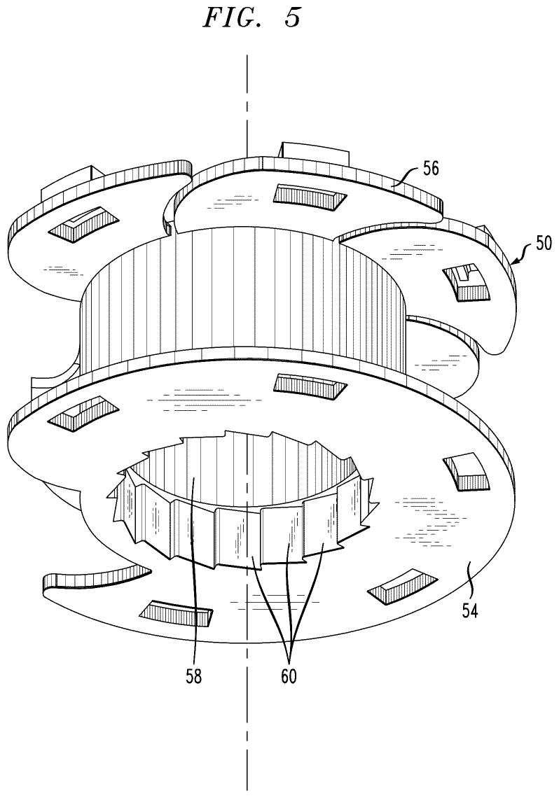

FIG. 4 is an isometric top view of a spool 50 that forms part of a storage device for an optical fiber ribbon, according to the invention. The spool 50 includes a hub 52 having an axis A, a bottom flange 54 at a first side end of the hub, and a top flange 56 at a second side end of the hub opposite the first side end. A circular spool opening 58 is formed axially through the hub 52, the bottom and the top flanges 54, 56, and, as seen in FIG. 5, a circular array of successive, inclined recesses 60 are formed circumferentially along the edge of the spool opening 58 in the bottom flange 54.

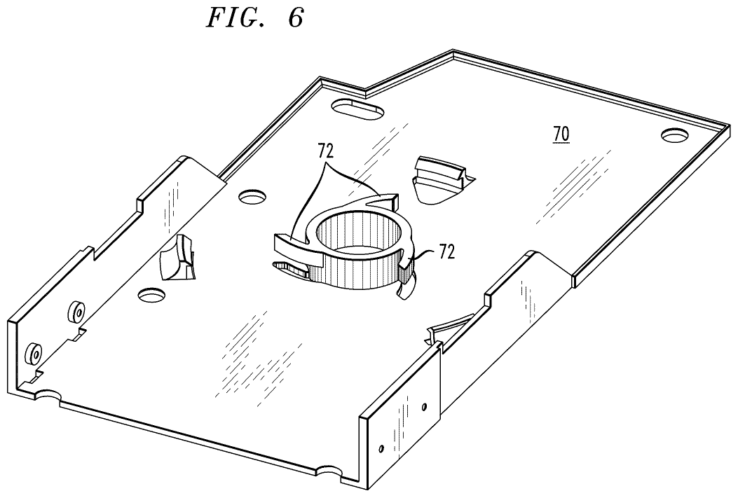

The inventive spool storage device also includes a base 70 as shown in FIG. 6. The base 70 has a number of circularly arrayed, upwardly projecting pawls 72 for engaging the recesses 60 along the edge of the spool opening 58 in the bottom flange 54. The recesses along the edge of the opening 58 in the bottom flange 54, and the projecting pawls 72 on the base 70, are dimensioned and configured so that when the bottom flange 54 is placed on the base 70 and the pawls 72 engage the recesses 60 along the edge of the opening 58 in the flange 54, the spool can be freely rotated about its axis in only one winding direction. In the illustrated embodiment, the winding direction is depicted by directional arrows 74 on the surface of the top flange 56 as shown in FIG. 4.

The spool hub 52 has a hook member 80 formed to project from the outer circumference of the hub 52, as shown in FIG. 4. The hook member 80 is dimensioned and formed to engage a midpoint of a length of an optical fiber ribbon that has been exposed inside the trunk cable 10 and placed on the hub 52, while maintaining a specified minimum bend radius for the ribbon. Thus, when the ribbon is engaged with the hook member 80 on the spool hub 52, and the spool 50 is engaged with the pawls 72 on the base 70 and rotated in the winding direction, the ribbon will loop safely around the hook member 80 at its midpoint and substantially equal lengths 82 of the ribbon will be wound next to one another on the hub for storage as illustrated in FIG. 7. Fibers of the ribbon are then accessible from the stored lengths 82 of the ribbon for splicing or other handling at the splice closure 14, or at another unit in which the inventive ribbon storage device is provided.

It will be appreciated that the inventive ribbon storage device can simplify and reduce preparation time for cable installations. For example. an installer does not need to cut fibers designated for splicing to a specific length since the maximum available length of the fibers is dependent only on the overall dimensions of the spool.

In addition, as seen in FIG. 4, the top flange 56 of the spool 50 preferably has passages 62 formed to allow fibers stored on the spool hub 52 to be routed out from the top surface of the flange 56 for splicing or other handling while maintaining the integrity of the fibers. The flange 56 can also have a number of circumferentially spaced, upwardly projecting hook members 64 to enable the top of the flange to form a storage basket for slack fiber inside the closure in which the spool 50 is provided. Adjustable and removable splice holders may also be integrated for ease of assembly and customization of orientation.

While the foregoing represents preferred embodiments of the present invention, it will be understood by persons skilled in the art that various changes, modifications, and additions can be made without departing from the spirit and scope of the invention, and that the invention includes all such changes, modifications, and additions that are within the scope of the following claims.

We claim:

1. A storage device for an optical fiber ribbon, comprising:
a spool including a hub having an axis, a bottom flange at a first side end of the hub, and a top flange at a second side end of the hub opposite the first side end;
a circular spool opening is formed axially through the hub, the bottom, and the top flanges, and a circular array of successive, inclined recesses are formed circumferentially along the edge of the spool opening in the bottom flange;
a base having a number of circularly arrayed, upwardly projecting pawls for engaging the recesses along the edge of the spool opening in the bottom flange, wherein the recesses along the edge of the opening in the bottom flange, and the projecting pawls on the base, are dimensioned and configured so that when the bottom flange is placed on the base and the pawls engage the recesses along the edge of the opening in the flange, the spool is freely rotatable about its axis in only one winding direction;
the spool hub has a hook member formed on the outer circumference of the hub, and the hook member is dimensioned and formed to engage a length of an optical fiber ribbon at a midpoint position along the length of the ribbon while a specified minimum bend radius for the ribbon is maintained, so that when the ribbon is engaged with the hook member and the spool is engaged with the pawls on the base and rotated in the winding direction, the ribbon remains looped around the hook member and two substantially equal lengths of the ribbon are wound next to one another on the hub for storage, and designated fibers of the ribbon are accessible from the stored lengths of the ribbon for splicing or other handling.

2. A storage device for an optical fiber ribbon according to claim 1, wherein the base is part of a splice closure.

3. A storage device for an optical fiber ribbon according to claim 2, wherein the base is part of a midspan terminal unit.

4. A storage device for an optical fiber ribbon according to claim 1, wherein the top flange of the spool has passages formed to allow the stored fibers to be routed out from the flange for splicing or other handling.

5. A storage device for an optical fiber ribbon according to claim 1, wherein the top flange of the spool has a number of circumferentially spaced upwardly projecting hook members for enabling the top surface of the flange to form a storage basket for slack fiber.
